(19) United States
(12) Patent Application Publication
(10) Pub. No.: US 2006/0119014 A1
(43) Pub. Date: Jun. 8, 2006

(54) Method of producing a container

(76) Inventors: Christopher R. Towers, Seattle, WA (US); William P. Stiles, Bothell, WA (US)

Correspondence Address: William Stiles, 927 Duchess Road, Bothell, WA, 98012-7020, US

(21) Appl. No.: 11/004,414

(22) Filed: Dec. 4, 2004

(51) Int. Cl. B29C 49/74

(52) U.S. Cl. 264/536; 264/161

(57) ABSTRACT

A method of producing a container with a desired opening profile. The process of blow molding is used to produce a bottle (10). The bottle (10) has one or more integral dimple (13), posts (15), or hole features, which are in radial alignment. These features may be produced in the molding process or produced in a separate operation once the bottle has been ejected from the mold press. The neck (12) is then trimmed away and the desired opening profile is created. A second part, a door (14), may then be snapped onto the container's radial features to form a hinge (16).

### CROSS-REFERENCE TO RELATED APPLICATIONS

Ser. No. 10/304,993

### FEDERALLY SPONSORED RESEARCH

Not Applicable

### SEQUENCE LISTING OF PROGRAM

Not Applicable

### BACKGROUND OF INVENTION—FIELD OF INVENTION

This invention is related to a method of producing a container, and more particularly, to a method of producing a container with a hinged door.

### BACKGROUND OF THE INVENTION

Blow molding is a plastic forming process that is especially well suited to the manufacturing of hollow-shaped parts, including plastic bottles. The process utilizes compressed gas to push a hot molten thermoplastic up against a mold cavity. Blow molding is widely used to manufacture food and beverage containers, personal care and pharmaceutical containers, automotive parts and double wall cases. Three common types of blow molding are: Extrusion Blow Molding, Injection Blow Molding and Stretch Blow Molding.

In the extrusion blow molding process, a parison, or tube of molten thermoplastic is extruded. The parison is commonly extruded downward between the two halves of an open blow mold. The mold closes around the tube, catching and holding the neck end open and pinching the bottom end closed. The mold consists of a manifold, which is a negative of the desired container shape. A blow pin is inserted into the neck opening. Compressed air is blown into the parison. This forces the parison to expand and fill the manifold. The container is given time to cool and solidify before the mold opens and the container in ejected. The excess pinched plastic is broken off of the neck and bottom areas as the mold is opening. In the injection blow molding process, the material is injection molded into a small cup shape. The hot material, still on the core pin, is then indexed to the blow molding station where it is blown into a bottle and allowed to cool. In Stretch blow molding, cup-shaped preforms are injection molded. The preforms may be stored for a period of time, then reheated to the proper temperature, and blown into containers.

The blow molding process can be used to process many different types of plastics, including HDPE, LDPE, PVC, PP and PETG. Many of these types of plastics are inexpensive and widely recycled. Blow molding allows for the production of a single part with enclosed space. This is advantageous over the process of injection molding, which would require the assembly of two or more parts to create an equivalent container. Injection molded plastics are generally more expensive than those used in blow molding. Injection molds are more expensive to produce than blow molds.

When bottles are produced in the blow molding process, a neck with an opening is formed. Generally the opening approximates a circular or oval shape, and is parallel to the bottle of the bottle. The process does not allow for an opening with a more complex contoured 3-D profile.

After the bottle has been ejected from the press, a secondary trimming operation can be used to remove the neck region and create an opening profile that is more suitable for the container's application.

Once the container has been molded and the profiled opening has been produced in a trimming operation, a second part, a hinged door, can be attached to cover the opening. The container can have integral features, which would allow the door, with similar opposing features, to snap onto the container and form a hinge. Dimples, posts or holes are examples of features in the container and the door that can be used to create a hinge. Dimples are impressions in a surface of a part. Posts are protrusions extending out of a surface of a part. And holes are windows that pass completely through a wall of a part. The integral hinge features can be produced on the container during the molding process or in a separate operation once the bottle has been ejected from the molding press.

### BACKROUND OF INVENTION—OBJECTS AND ADVANTAGES

Accordingly, besides the objects and advantages of the container described in our above patent, several objects and advantages of the present invention are:

(a) to provide a container which can be produced from recycled materials.

(b) to provide container that can itself be recycled.

(c) to provide a container which is inexpensive to produce.

(d) to provide a container with a contoured opening profile.

(e) to provide a container which is strong, yet lightweight.

(f) to provide a container with a hinged door;

(g) to provide a container which has low mold production costs.

(h) to provide a container with a low part count.

Further objects and advantages are to provide a process for producing a container with a profiled opening which can not be produced by the process of blow molding alone and can not be produced in other molding processes, including injection molding, without assembling several parts together. Still further objects and advantages will become apparent from a consideration of the ensuing description and drawings.

### SUMMARY

In accordance with the present invention, the process of blow molding produces a bottle. The bottle has one or more integral dimple, hole, or post features, which are in radial alignment. In a secondary operation, the neck region is trimmed away and a desirable opening profile is created.

### DRAWINGS—FIGURES

FIG. 1 is an isometric view of the untrimmed blow molded container.

FIG. 2 is a right side view of the untrimmed container.

FIG. 3 is an isometric view of the container. The container neck has been trimmed off of the container.

FIG. 4 is a ride side view of the container. The container has been trimmed off of the container.

FIG. 5 is an isometric view of the container and the door. The post features of the door are almost aligned with the dimple features of the container.

FIG. 6 is a detailed view of FIG. 5.

FIG. 7 is an isometric view of the container with the hinged door attached. The door is in the closed position.

FIG. 8 is a right side view of the container with the hinged door attached. The door is in the closed position.

FIG. 9 is a cross-sectional view taken along line 9-9 of FIG. 8

FIG. 10 is a detailed view of FIG. 9. The dimple features of the container are in alignment with the post features of the door.

FIG. 11 is an alternative configuration to that of FIG. 10. The post features of the container are in alignment with the dimple features of the door.

FIG. 12 is an isometric view of a container with an integrated handle molded into the container.

### DRAWINGS—REFERENCE NUMERALS

10 Blow Molded Container—Untrimmed
11 Blow Molded Container—Trimmed
12 Container Neck
13 Integral Dimple Features
14 Door
15 Integral Post Features
16 Hinge
17 Blow Molded Container—Trimmed—Integral Handle Embodiment
18 Handle—Integral Handle Embodiment

### DETAILED DESCRIPTION OF INVENTION

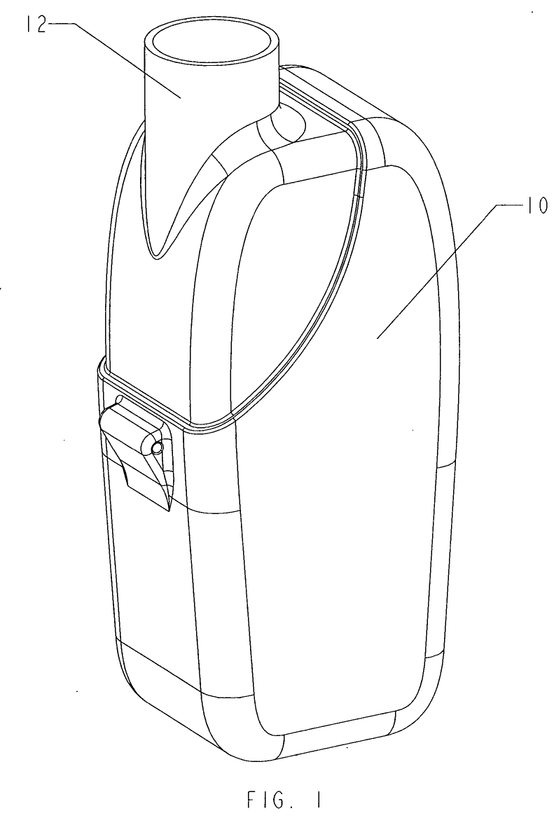

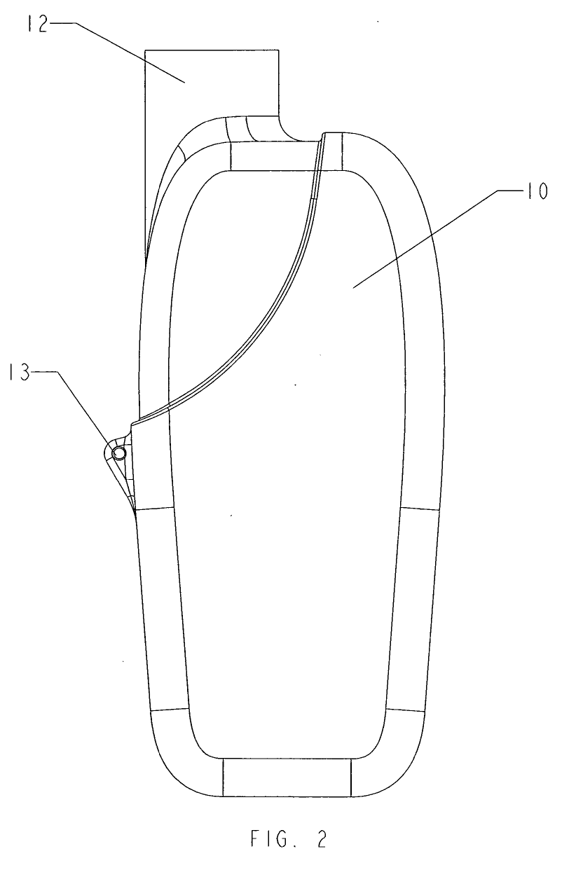

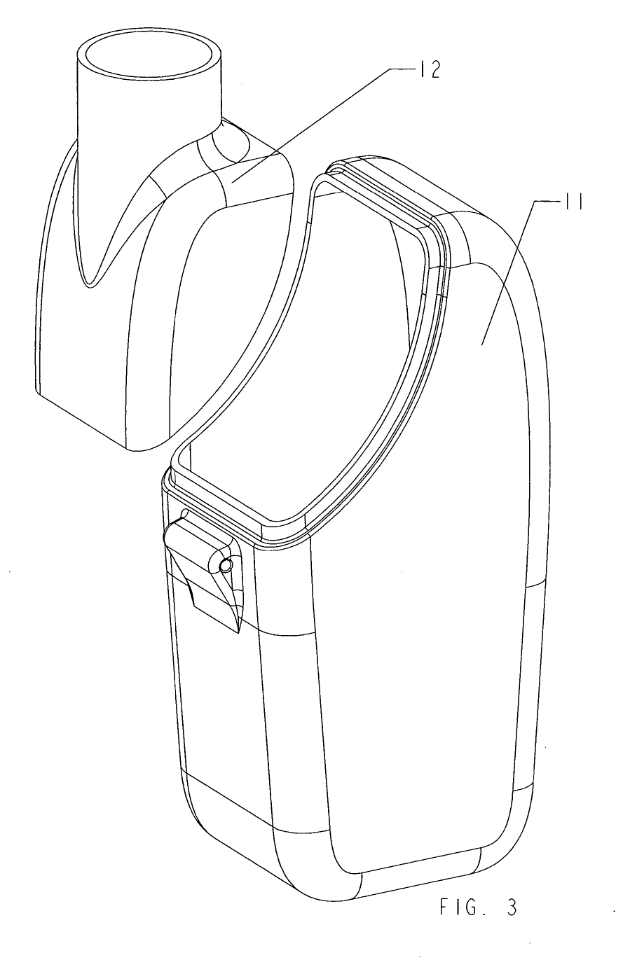

FIG. 1 illustrates the untrimmed blow molded container 10 as it would appear after being ejected from the molding press. The container has a neck 12 with an opening. The opening approximates a circular or oval shape, and is parallel to the bottle of the container. The blow molding process does not easily allow for an opening with a more complex contoured 3-D profile. FIG. 2 illustrates a right side view of the container 10. The integral dimple features 13 can be seen in this view. The direction of the tooling axis is perpendicular to this view. The two mold halves split along the axis of symmetry of this container. In this particular embodiment, the region surrounding the neck 12 is stepped down. This will allow for the door to be nesting onto this container step once the neck 12 is trimmed. FIG. 3 illustrates a secondary trimming operation, which separates the neck 12 from the container 11. The trimming operation provides an opening with a contoured, 3-D profile. This would not be possible to produce in the blow molding process. FIG. 4 is a right side view of the neck 12 separated from the container 11.

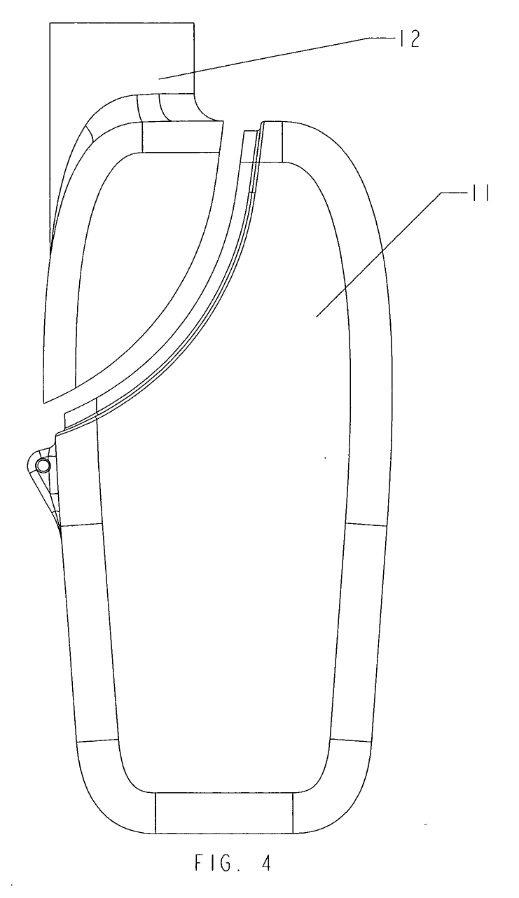

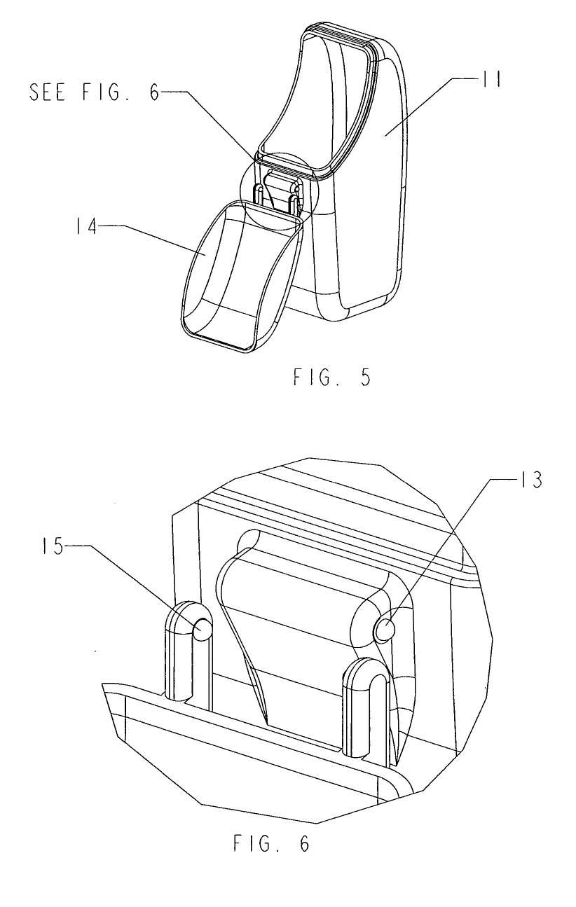

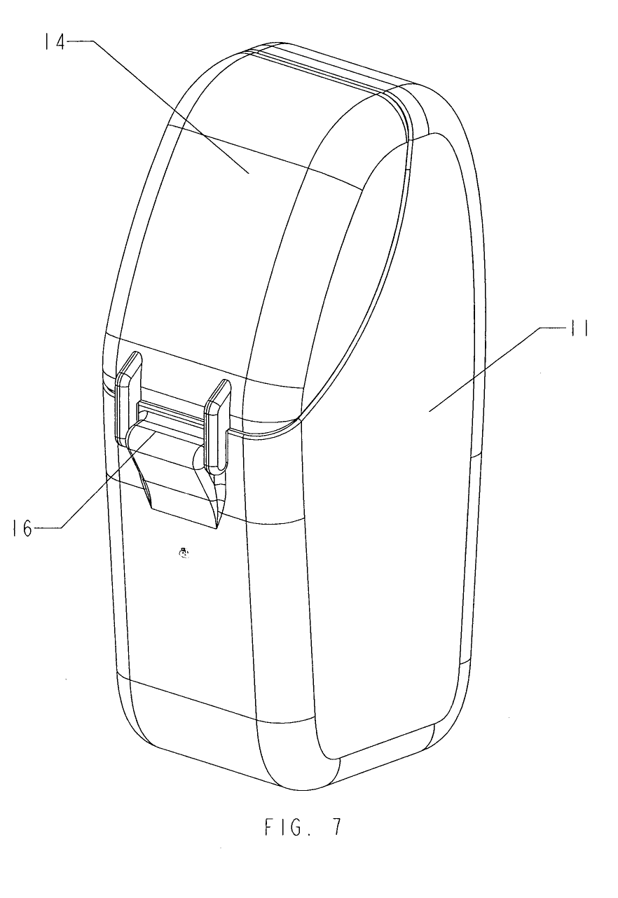

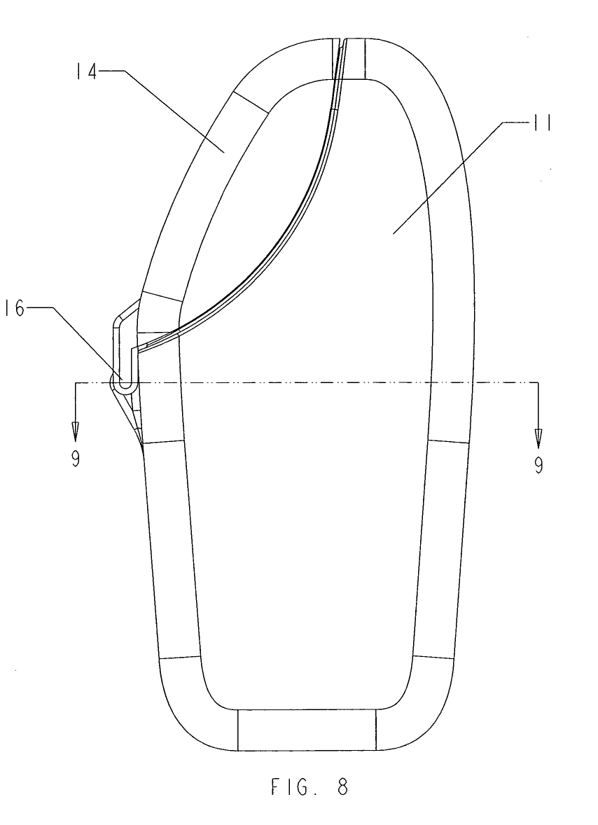

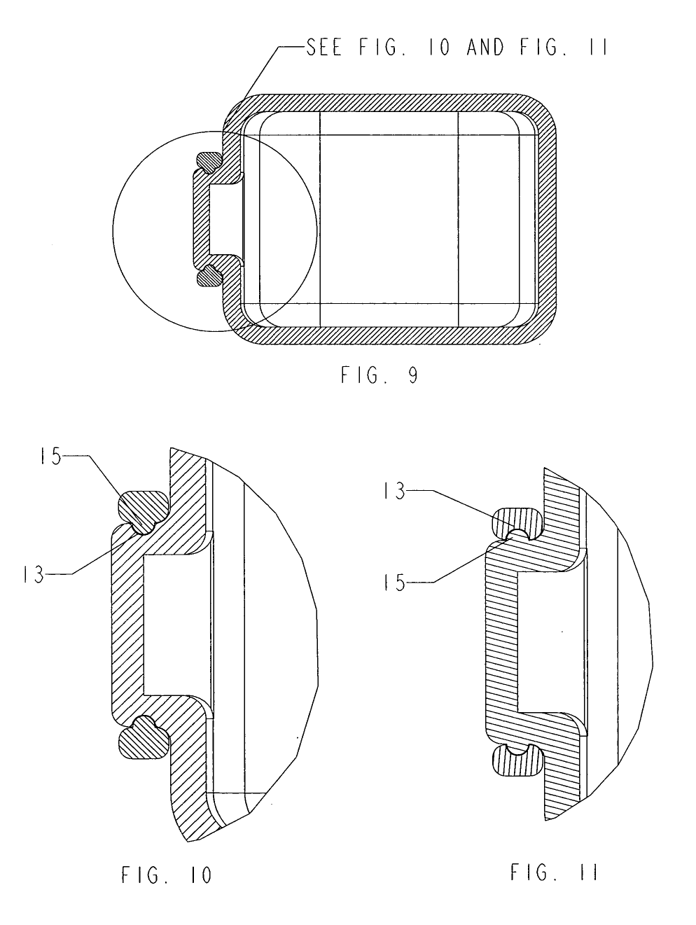

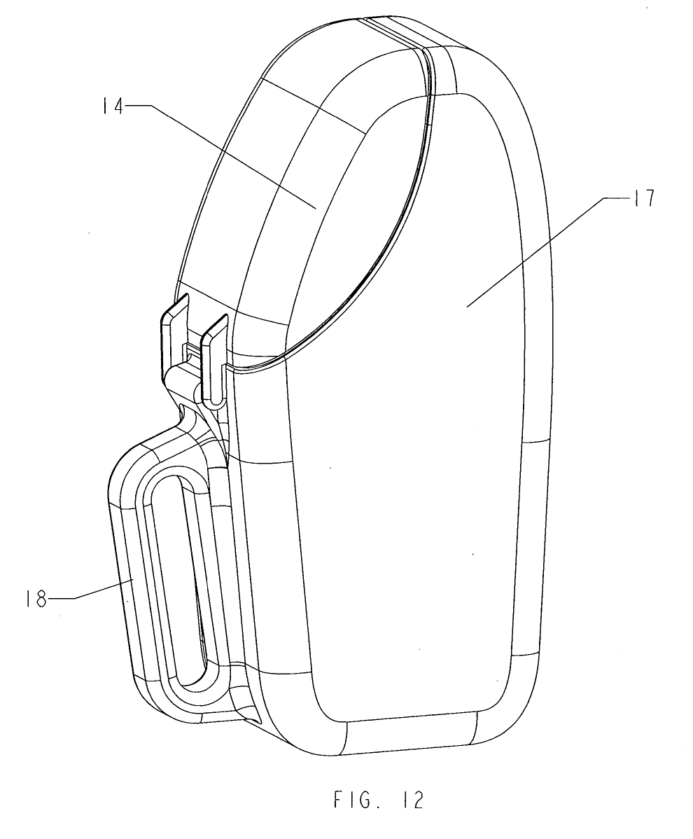

FIG. 5 illustrates the door 14 and the trimmed container 11. FIG. 6 is a detailed view of FIG. 5. The container's integral dimple features 13 are in close proximity to the door's integral post features 15. Once the dimple and post features are forced into alignment, a hinge is formed. FIG. 7 illustrates the door 14 covering the container opening. The door 14 can rotate open on the hinge 16. FIG. 8 illustrates a right side view of the door 14 attached to the container 11. The hinge 16 is visible in this view. FIG. 9 is a cross-section of the container. The cross-section passes through the hinge 16. FIG. 10 is a detailed view of FIG. 9. The hinge is formed when the dimples 13 and posts 15 are forced into alignment. FIG. 11 is an alternative embodiment of the hinge design. The dimples 13 are integral to the door 14 and the posts 15 are integral to the container 11. FIG. 12 illustrates an embodiment in which the container is molded with a handle 18. This handle design is similar to those found on common blow molded galloon milk jugs.

Although the description above contains many specificities, these should not be construed as limiting the scope of the invention but as merely providing illustrations of some of the presently preferred embodiments of this invention.

Thus the scope of the invention should be determined by the appended claims and their equivalents, rather than by the examples given.

We claim:

1. A method of manufacturing a container; said container comprising:
(a) an opening
(b) one or more of the following integral features in radial alignment in any combination: dimples, posts, holes;
the method comprising the steps:
(a) producing a container by the process of blow molding; the container having said integral dimples, holes and or posts;
(b) trimming of the container to remove the neck and to produce a desired opening profile.

2. The method of claim 1, further including the method of attaching a door which covers all or part of the container opening; the door having one or more integral radial features which oppose said radial features of the container; when said radial features of the container and the door are forced into alignment, a hinge is formed.

3. The method of claim 2, further including the method of producing one or more retention features, which retain said door in the closed position.

4. A method of manufacturing a container; said container comprising
(a) an opening
(b) one or more of the following integral feature in radial alignment in any combination: dimples, posts, holes;
the method comprising the steps:
(a) producing a container by the process of blow molding;
(b) producing said dimples, holes or posts in said container;
(c) trimming of the container to remove the neck and produce a desired opening profile;

5. The method of claim 4, further including the method of attaching a door which covers all or part of the container opening; the door having one or more integral radial features which oppose said radial features of the container; when said radial features of the container and the door are forced into alignment, a hinge is formed.

6. The method of claim 5, further including the method of producing one or more retention features, which retain said door in the closed position.
